(19) United States
(12) Patent Application Publication
(10) Pub. No.: US 2011/0100664 A1
(43) Pub. Date: May 5, 2011

(54) STRIKING TOOL

(76) Inventor: CHIA-YUN LIN, Taichung City (TW)

(21) Appl. No.: 12/612,532

(22) Filed: Nov. 4, 2009

(51) Int. Cl. B25C 9/00

(52) U.S. Cl. 173/162.2; 81/44

(57) ABSTRACT

A striking tool has a shaft, two plugs, two springs and a grip. The shaft has an outer surface, a grip section and two spring sections. The grip section is formed on and protrudes from the outer surface of the shaft and has a diameter and two ends. The spring sections are respectively adjacent to the ends of the grip section and each spring section has a diameter smaller than the diameter of the grip section. The plugs are slidably and respectively mounted around the spring sections. The springs are compressibly and respectively mounted around the spring sections and each spring abuts a corresponding plug and the grip section. The grip is slidably mounted around the grip section and is securely connected with both of the plugs.

### BACKGROUND OF THE INVENTION

1. Field of the Invention

The present invention relates to a striking tool, and more particularly to a striking tool that can cushion and absorb vibration conducted to a grip.

2. Description of Related Art

A conventional striking tool comprises a shaft and a grip and may be hit to punch nails flush with a work surface. The shaft is made of metal. The grip is solid and is securely mounted around the shaft.

However, vibration caused by striking the tool is conducted to the grip which is held firmly so raising a risk of the tool moving to a different location and a following strike missing the tool or damaging the work surface or inducing pain or hand-arm vibration syndrome in a user. To overcome the shortcomings, the present invention tends to provide a striking tool to mitigate the aforementioned problems.

### SUMMARY OF THE INVENTION

The main objective of the invention is to provide a striking tool that can cushion and absorb vibration conducted to a grip to reduce risk of injury and hand-arm vibration syndrome.

A striking tool has a shaft, two plugs, two springs and a grip. The shaft has an outer surface, a grip section and two spring sections. The grip section is formed on and protrudes from the outer surface of the shaft and has a diameter and two ends. The spring sections are respectively adjacent to the ends of the grip section and each spring section has a diameter smaller than the diameter of the grip section. The plugs are slidably and respectively mounted around the spring sections. The springs are compressibly and respectively mounted around the spring sections and each spring abuts a corresponding plug and the grip section. The grip is slidably mounted around the grip section and is securely connected with both of the plugs.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a striking tool in accordance with the present invention;

FIG. 2 is an exploded perspective view of the striking tool in FIG. 1;

FIG. 3 is a side view in partial section of the striking tool in FIG. 1;

FIG. 4 is an operational perspective view of the striking tool in FIG. 1, shown struck by a hammer;

FIG. 5 is an operational side view in partial section of the striking tool in FIG. 3 showing the shaft descending; and

FIG. 6 is an operational side view in partial section of the striking tool in FIG. 5 showing the shaft ascending.

### DETAILED DESCRIPTION OF PREFERRED EMBODIMENT

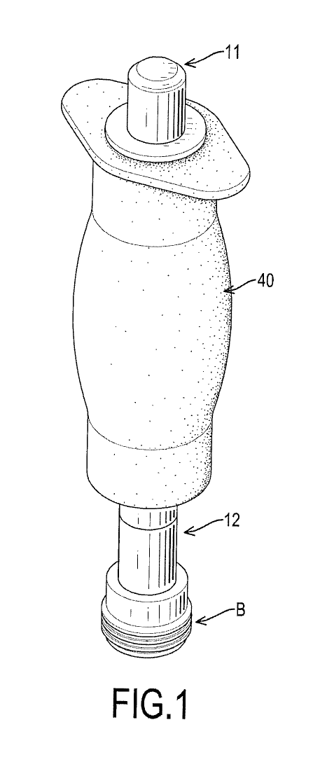

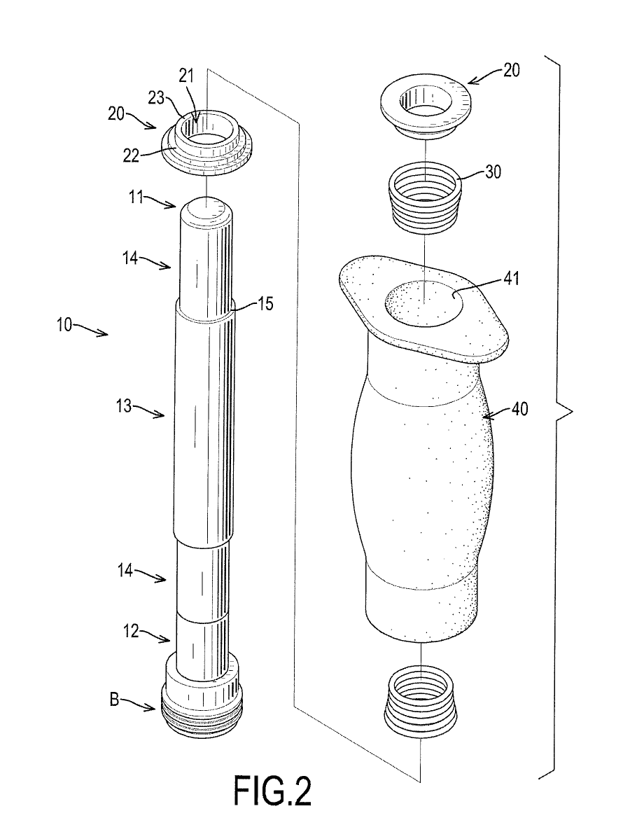

With reference to FIGS. 1 and 2, a striking tool in accordance with the present invention comprises a shaft (10), two plugs (20), two springs (30) and a grip (40).

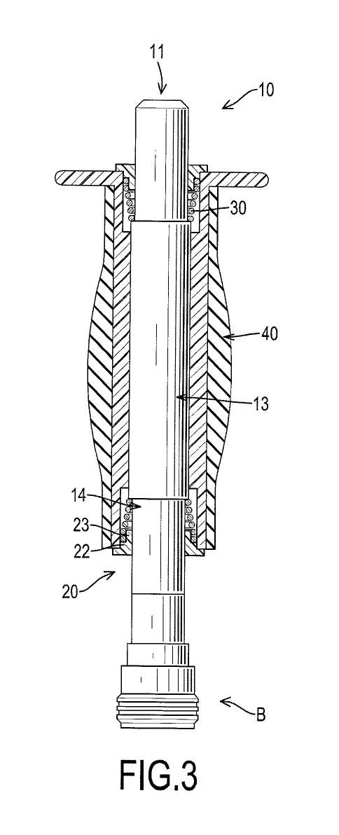

With further reference to FIG. 3, the shaft (10) is made of metal, is cylindrical and has an outer surface, a central segment, a struck end (11), an operational end (12), a grip section (13), two spring sections (14), and two shaft rims (15).

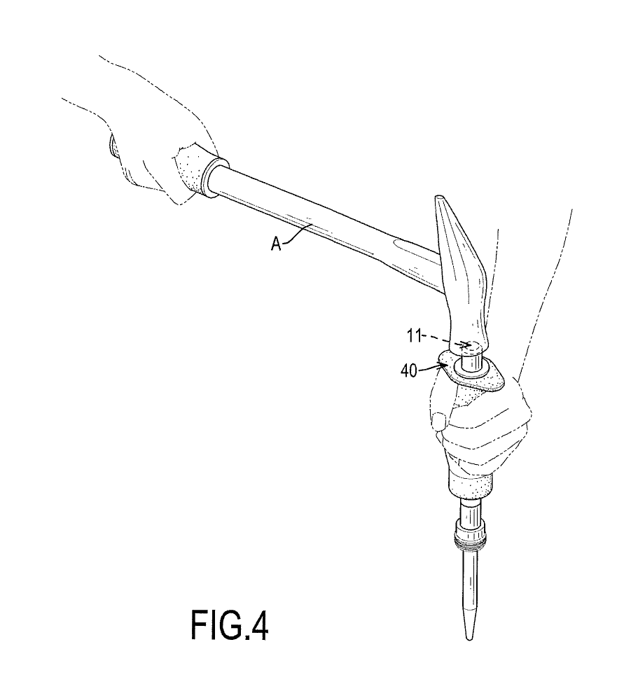

The struck end (11) is struck by a hammer, as shown in FIG. 4.

The operational end (12) is opposite to the struck end (11). Preferably, the operational end (12) is connected to a quick-release device (B). The quick-release device (B) is capable of connecting to various chisels or other hand tools and the hand tool in accordance with the present invention can be used as a chisel or other hand tools for striking. The structure of the quick-release device (B) is well known in the prior art, so detailed description is omitted.

The grip section (13) is formed on and protrudes from the outer surface at the central segment of the shaft (10). The grip section (13) has two ends and a diameter.

The spring sections (14) are respectively adjacent to the ends of the grip section (13) and each spring section (14) has a diameter. The diameter of each spring sections (14) is smaller than the diameter of the grip section (13).

The shaft rims (15) are round and respectively defined around the ends of the grip sections (13).

The plugs (20) are slidably and respectively mounted around the spring sections (14). Each plug (20) has a maximal diameter, a plug hole (21), a plug rim (22) and a clamp rim (23).

The plug hole (21) is axially defined through the plug (20).

The plug rim (22) is formed on and protrudes from the plug (20), is defined around the plug hole (21), protrudes toward the grip section (13) and has an external diameter. The external diameter of the plug rim (22) is smaller than the maximal diameter of the plug (20).

The clamp rim (23) is formed on and protrudes from the plug rim (22), is defined around the plug hole (21), protrudes toward the grip section (13) and has an external diameter. The external diameter of the clamp rim (23) is smaller than the external diameter of the plug rim (22).

The springs (30) are compressibly and respectively mounted around the spring sections (14) and each spring (30) has two ends. The ends of each spring (30) abut a corresponding plug rim (22) and a corresponding shaft rim (15).

The grip (40) is a plastic handle covered with rubber for holding. The grip (40) is slidably mounted around the grip section (13), is securely connected with both of the plugs (20) and has a grip hole (41) and two ends.

The grip hole (41) is defined axially through the grip (40) and has two openings. The openings of the grip hole (41) are respectively and securely mounted around the plug rims (22) to allow the springs (30) to be clamped between the grip (40) and the clamp rims (23). Because the openings of the grip (40) are mounted securely around the plug rims (22), the grip (40) moves synchronously with both of the plugs (20).

The ends of the grip (40) abut both of the plugs (20) beside the plug rims (22) and the clamp rims (23).

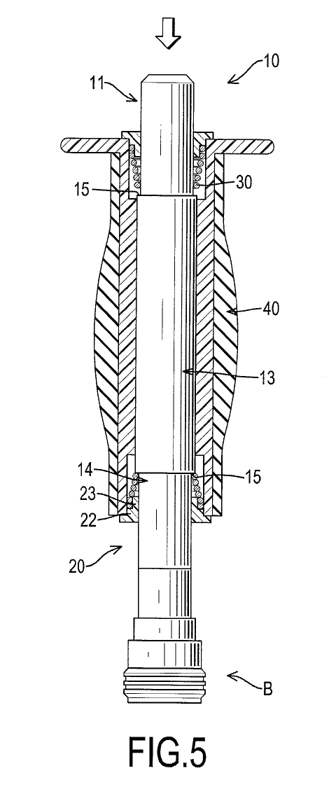

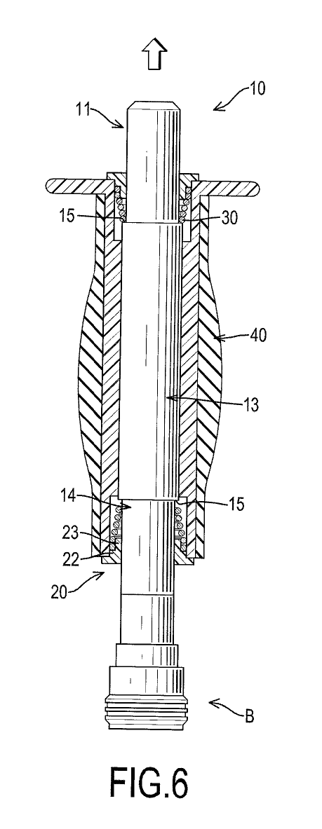

With reference to FIGS. 1 and 4, the operational end (12) is placed toward a workpiece and then the struck end (11) is struck by a hammer (A). With further reference to FIGS. 5 and 6, the shaft (10) moves toward the workpiece when the struck end (11) is struck. Consequently, the shaft rim (15) which is close to the operational end (12) descends to compress the corresponding spring (30). With the compressed spring (30), vibration is effectively cushioned and absorbed so reducing likelihood of injury and hand-arm vibration syndrome.

When the shaft (10) is pushed back by a reacting force and ascends, the shaft rim (15) which is close to the struck end (11) ascends to compress the corresponding spring (30). Similarly, the compressed spring (30) cushions and absorbs vibration and reduces likelihood of injury.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A striking tool comprising:
a shaft having
an outer surface;
a central segment;
a struck end;
an operational end opposite to the struck end;
a grip section formed on and protruding from the outer surface at the central segment of the shaft and having
two ends; and
a diameter;
two spring sections respectively adjacent to the ends of the grip section, each having
a diameter smaller than the diameter of the grip section;
two shaft rims respectively defined around the ends of the grip sections;
two plugs slidably and respectively mounted around the spring sections;
two springs compressibly and respectively mounted around the spring sections, each having
two ends abutting a corresponding plug and a corresponding shaft rim; and
a grip slidably mounted around the grip section and securely connected with both of the plugs.

2. The striking tool as claimed in claim 1, wherein
each plug has
a maximal diameter;
a plug hole axially defined through the plug; and
a plug rim formed on and protruding from the plug, defined around the plug hole, protruding toward the grip section and having
an external diameter smaller than the maximal diameter of the plug;
one of the ends of each spring abuts a corresponding plug rim; and
the grip has
a grip hole defined axially through the grip and having two openings which are respectively and securely mounted around the plug rims.

3. The striking tool as claimed in claim 2, wherein
each plug has
a clamp rim formed on and protruding from the plug rim, defined around the plug hole, protruding toward the grip section and having an external diameter smaller than the external diameter of the plug rim; and
the grip has
two ends abutting both of the plugs beside the plug rims and the clamp rims.

4. The striking tool as claimed in claim 1, wherein the operational end is connected to a quick-release device.

5. The striking tool as claimed in claim 2, wherein the operational end is connected to a quick-release device.

6. The striking tool as claimed in claim 3, wherein the operational end is connected to a quick-release device.
